(19) United States
(12) Patent Application Publication
(10) Pub. No.: US 2016/0294250 A1
(43) Pub. Date: Oct. 6, 2016

(54) ELECTRIC MOTOR GENERATOR WORKING WITHOUT BEARINGS

(71) Applicant: John Jean Rottersmann, Westerville, OH (US)

(72) Inventor: John Jean Rottersmann, Westerville, OH (US)

(21) Appl. No.: 14/674,174

(22) Filed: Mar. 31, 2015

(51) Int. Cl. H02K 7/02; H02K 7/09

(52) U.S. Cl. CPC H02K 7/025; H02K 7/09

(57) ABSTRACT

An electrical motors/generator system working without a bearing between the rotor and the stator is provided. The stator may substantially surround the rotor within a rotary cavity. The rotor may include a flywheel coupled to a flywheel shaft, wherein the flywheel shaft extends beyond the rotary cavity so as to rotably connect to mounted magnetized plates. The opposing ends of the flywheel shaft may be received by shaft recesses formed into each magnetized plate, wherein each recess is dimensioned and adapted to receive electromagnet and electromagnet coils along portions of the flywheel shaft in the shaft recess. Adjacent to the received electromagnets, an annular magnet is disposed about a portion of the flywheel shaft not in the shaft recess. The magnets are thus in the close proximity to the electromagnet/coils so that magnetic fields generated by the electromagnet coils generate a force on the magnets arranged around portions of the flywheel shaft of the rotor thereby causing the rotor to rotate in a magnetically controlled manner. Underneath the stator and the rotor a bottom magnet may be disposed so as to decrease the effect of the rotor self-weight

### CROSS-REFERENCE TO RELATED APPLICATION

This application claims the benefit of priority of U.S. provisional application No. 61/994,202, filed 16 May 2014, the contents of which are herein incorporated by reference.

### BACKGROUND OF THE INVENTION

The present invention relates to electric motors and electric generators and, more particularly, to an electric motor and electric generator that works without bearings.

Electric motors and electric generators require relative movement between two bodies, a stationary body (stator) and a rotary body (rotor). The rotor is typically attached to the stator by a bearing. This bearing causes friction. Such friction produces additional (wasteful) work, pollution and wear over time, all of which have costs: lost energy, opportunity costs, and maintenance costs.

The applicant also believes that the present invention will resist any collisions with heavy stationary objects, and has the potential of making the internal combustion engine and the use of batteries obsolete.

As can be seen, there is a need for an electric motor and electric generator that works without bearings, and so minimizing pollution, maintenance, and other costs.

### SUMMARY OF THE INVENTION

In one aspect of the present invention, an electric motor-generator includes a stator extending from a front sidewall to a rear sidewall; a rotary cavity formed between the front and rear sidewalls of the stator; a rotor centered in the rotary cavity, wherein the rotor provides a flywheel shaft having a front end and an opposing rear end, each end extending beyond the rotary cavity, wherein each end is rotably connected to a magnetized plate; a flywheel coupled to the flywheel shaft; and an axis of rotation oriented generally parallel to the front and rear sidewalls; a shaft recess formed into each magnetized plate, wherein each shaft recess provides a plurality of electromagnets and electromagnet coils disposed about each end of the flywheel shaft; and an annular magnet dispose near each end of the flywheel shaft not in its respective shaft recess.

In another aspect of the present invention, electric motor-generator includes a stator extending from a front sidewall to a rear sidewall, wherein the stator provides a rotary cavity formed between the front and rear sidewalls of the stator; a plurality of winding apertures formed by the front and rear sidewalls so as to be disposed concentrically about the rotary cavity; and a plurality of motor windings extending between adjacent winding apertures; a rotor centered in the rotary cavity, wherein the rotor provides a pair of magnetized plates, wherein each magnetized plate provides a plurality of electromagnetic connectors; a flywheel shaft having a front end and an opposing rear end, each end extending beyond the rotary cavity so as to be connected to one of the pair of magnetized plates; an axis of rotation oriented generally perpendicular to the front and rear sidewalls; a front ball and a rear ball, each ball operatively engaging an opposing end of the flywheel shaft so as to facilitate high rotational speeds about the axis of rotation; a flywheel coupled to the flywheel shaft; and a plurality of carbon fiber disposed along the circumference of the flywheel; a shaft recess formed into each magnetized plate, wherein each shaft recess provides a plurality of electromagnets and electromagnet coils disposed about each end of the flywheel shaft; an annular magnet dispose near each end of the flywheel shaft not in its respective shaft recess, wherein each annular magnet including a plurality of north and south magnet internals; a mounting box having a front mounting wall and a rear mounting wall interconnected by a base wall, wherein each mounting wall is connected to one magnetized plate; and a bottom magnet disposed between the base wall and the stator.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a section view of an exemplary embodiment of the present invention, taken along line 2-2 in FIG. 1;

FIG. 3 is a detail section view of an exemplary embodiment of the present invention;

FIG. 4 is a section view of an exemplary embodiment of the present invention, taken along line 4-4 in FIG. 2;

FIG. 5 is a detail section view of an exemplary embodiment of the present invention;

FIG. 6 is a perspective view of an exemplary embodiment of the present invention, demonstrating an opposing rotation configuration; and

FIG. 7 is a section view of an exemplary embodiment of the present invention, taken along line 7-7 in FIG. 6, demonstrating the rotation of the opposing rotation configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an electrical motors/generator system working without a bearing between the rotor and the stator. The stator may substantially surround the rotor within a rotary cavity. The rotor may include a flywheel coupled to a flywheel shaft, wherein the flywheel shaft extends beyond the rotary cavity so as to rotably connect to mounted magnetized plates. The opposing ends of the flywheel shaft may be received by shaft recesses formed into each magnetized plate, wherein each recess is dimensioned and adapted to receive electromagnet and electromagnet coils along portions of the flywheel shaft in the shaft recess. Adjacent to the received electromagnets, an annular magnet is disposed about a portion of the flywheel shaft not in the shaft recess. The magnets are thus in the close proximity to the electromagnet/coils so that magnetic fields generated by the electromagnet coils generate a force on the magnets arranged around portions of the flywheel shaft of the rotor thereby causing the rotor to rotate in a magnetically controlled manner. Underneath the stator and the rotor a bottom magnet may be disposed so as to decrease the effect of the rotor self-weight.

Electrical motors and generators are machines which either convert electrical energy inputs into forces or applied kinetic energy inputs into electrical energy. In principle, any electrical generator can also be operated as a motor and vice-versa. In such machines there are essentially two main parts between which relative movement is a functional necessity, one of which parts is usually stationary (stator) and the other rotary (rotor).

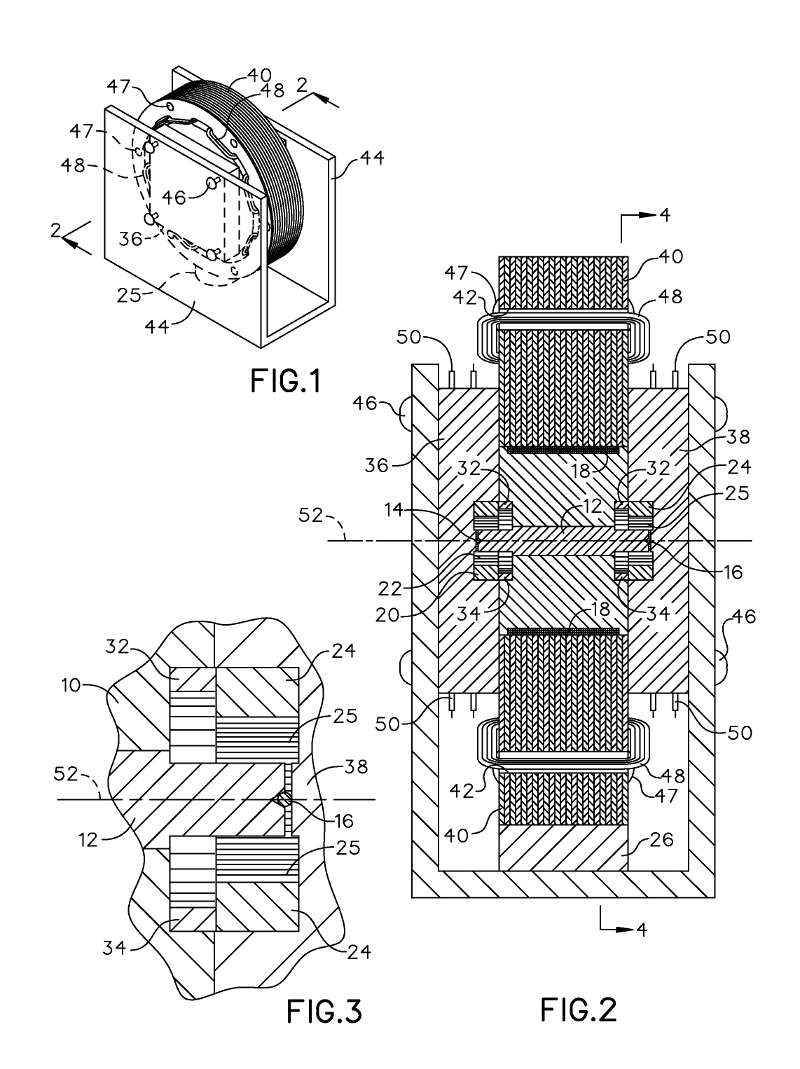

Referring to FIGS. 1 through 7, the present invention may include an electrical motors/generator system 100 working without a bearing. The electrical motors/generator system 100 may include a portion of a stator 40 substantially surrounding a rotor within a rotary cavity. The portion of the stator 40 and its rotary cavity may be dimensioned and adapted to keep the rotor controlled in case of mechanical problems with the rotor running at very high speed. The portion of the stator 40 may include a plurality of laminates held together by connectors 47, such as rivets, bookended by a first sidewall to a second sidewall. The portion of the stator 40 may form the generally circular, centrically disposed rotary cavity that extends from the first side wall to the second side wall. A center of the rotary cavity may be shared by an axis of rotation 52 about which the surrounded rotor rotates. Each sidewall may form a plurality of winding apertures 42 disposed concentrically about the rotary cavity, each winding aperture 42 dimensioned and adapted to operatively engage motor windings 48 extending between adjacent winding apertures 42.

Each windings 48 may be adapted to control the size of the generated centrifugal forces to allow higher rotational speeds. The current in each windings 48 may be direct or alternative with different frequencies including the frequencies developed by the rotor itself.

In certain embodiments, the two opposing ends of the stator 40 may be equipped with one fine thread screw at each end so as to protect the windings 48 from being damaged by the magnetized plates 36, 38, wherein there may be a clearance of between 0.005 and 0.010 inch between the rotary balls 14, 16 and each fine thread screw.

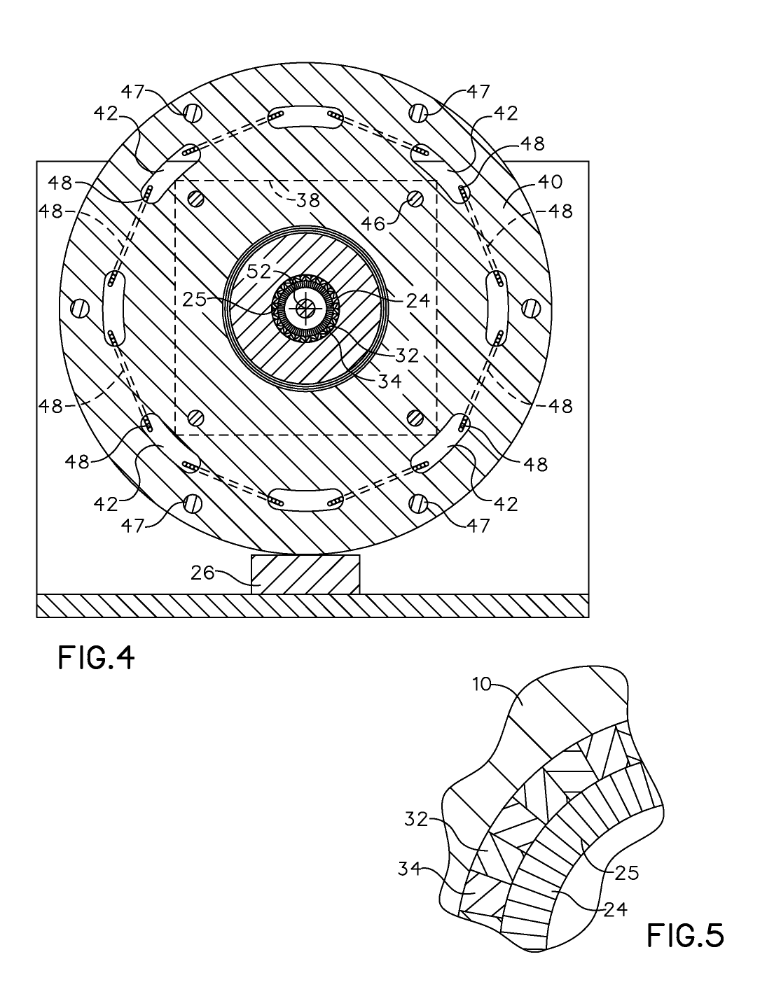

The rotor may include a flywheel 10 coupled to a flywheel shaft 12, wherein the axis of rotation 52 is oriented generally perpendicular to the sidewalls of the portion of the stator 40. A plurality of carbon fibers 18 may be disposed along the circumferential surface of the flywheel 10 so as to interface with the portion of the stator 40 that formed the rotary cavity, as illustrated in FIG. 2. The flywheel shaft 12 may have a rear end and an opposing front end. The front end and the rear end may be mounted to a front magnetized plate 36 and a rear magnetized plate 38, respectively. The front magnetized plate 36 and the rear magnetized plate 38 may each form a shaft recess, wherein the front and rear end, respectively, are received. The diameter of each shaft recess may be dimensioned and adapted to receive electromagnets and electromagnet coils about the ends of the flywheel shaft 12, as illustrated in FIGS. 2 and 4. The front end and the rear end may operatively engage a front rotary ball 14 and a rear rotary ball 16, respectively, to facilitate high rotational speeds about the axis of rotation 52.

The front magnetized plate 36 and the rear magnetized plate 38 may be mounted to opposing ends of a mounting box 44, 54 by fasteners 46, such as screws. The front magnetized plate 36 and the rear magnetized plate 38 may each provide a plurality of electro-magnetic connectors 50.

The rotor includes a plurality of magnets, electromagnets and electromagnet coils arranged around portions of the flywheel shaft 12. The magnets are thus in the close proximity to the electromagnet coils so that magnetic fields generated by the electromagnet coils generate a force on the magnets arranged around portions of the flywheel shaft 12 of the rotor thereby causing the rotor to rotate in a magnetically controlled manner.

The plurality of magnets may include a plurality of front north magnets 28 and front south magnets 30 intervals that form a front annular magnet near the front end of the flywheel shaft 12. The plurality of magnets may include a plurality of rear north magnets 32 and rear south magnets 34 intervals that form a rear annular magnet near the rear end of the flywheel shaft 12. The front and rear annular magnets may be disposed about the portion of the flywheel shaft 12 that is not in the shaft recess.

A front electromagnet 20 and front electromagnet coils 22 may be disposed about the portion of the front end of the flywheel shaft 12 in the front magnetized plate 36 shaft cavity. A rear electromagnet 24 and rear electromagnet coils 25 may be disposed about the portion of the rear end of the flywheel shaft 12 in the rear magnetized plate 36 shaft cavity.

The plurality of electromagnets and electromagnet coils may control the rotational speed of the flywheel 10, whereby the flywheel 10 is the only moving part as the electrical motors/generator system 100 acts as an electric motor-generator.

A bottom electromagnet 26 may disposed between a base portion of the mounting box 44, 54 and the portion of the stator 40 so as to decrease the effect of the rotor self-weight.

A method of making the present invention may include the following. In certain embodiments, the rotor may be sized and adapted differently. In a first embodiment, the rotor may include a piece of magnetized steel that is treated by hot and cold forgings for maximum solidity and pierced for the flywheel shaft 12 which is tight to the rotor with Loctite of similar strong adhesives. In a second embodiment, the rotor may include the center of the laminates used for the stator 40. The rotor may have to be slightly longer to compensate for the presence of paper, but will be better if the stator coils are submitted to alternative currents. In a third embodiment, the rotor may include the main outside part being made of a cylinder made of magnetized steel.

The method of using the present invention may include the following. The electrical motors/generator system 100 disclosed above may be provided. A user may apply electrical energy inputted through the electromagnetic connectors 50 so as to produce kinetic forces. Alternatively, the user may subject the system 100 to kinetic energy to output electrical energy through the electromagnetic connectors 50.

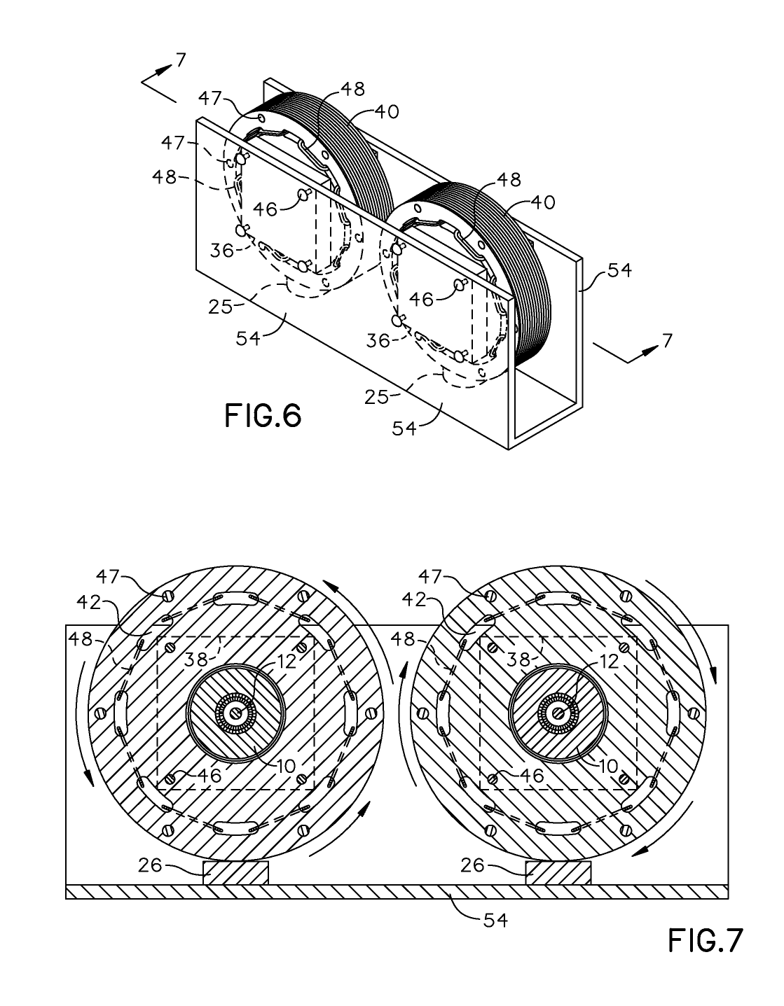

In certain embodiments, two electrical motors/generator systems 100 can be coupled together in one mounting box 54 in an opposing rotation configuration, as illustrated in FIGS. 6 and 7. When coupled together, the two systems 100 may be dimensioned and adapted so that each system 100 are identically sized yet a first system 100 is oriented upside up, while a second system 100 is oriented upside down, thus, the two coupled systems 100 are running at the same speeds, but rotate in opposite directions.

In an alternative embodiment, the electrical motors/generator system 100 may be assembled with a predetermined quantity of windings 48 for distinct purposes. For example, a first system 100 assembly may have only one set of windings 48 to be used only with the rotation axis vertical and with a wide flywheel 10; a second system 100 assembly may have two sets of windings 48, as disclosed above, to be used especially on cars, trucks, trains, boats, airplanes and the like; and a third system 100 assembly with the two sets of windings 48, but with the addition of a big, heavy, large rotating and purely mechanical flywheel 10 on the top of the motor with the motor and its rotation axis vertical. The third assembly to be used especially in big power stations and electric grids to absorb and restitute all high and in excess energy generated by sun, wind and sea motions.

It should be understood, of course, that the foregoing relates to exemplary embodiments of the invention and that modifications may be made without departing from the spirit and scope of the invention as set forth in the following claims.

What is claimed is:

1. An electric motor-generator comprising:
a stator extending from a front sidewall to a rear sidewall;
a rotary cavity formed between the front and rear sidewalls of the stator;
a rotor centered in the rotary cavity, wherein the rotor comprises:
a flywheel shaft having a front end and an opposing rear end, each end extending beyond the rotary cavity, wherein each end is rotably connected to a magnetized plate;
a flywheel coupled to the flywheel shaft; and
an axis of rotation oriented generally parallel to the front and rear sidewalls;
a shaft recess formed into each magnetized plate, wherein each shaft recess provides a plurality of electromagnets and electromagnet coils disposed about each end of the flywheel shaft; and
an annular magnet dispose near each end of the flywheel shaft not in its respective shaft recess.

2. The electric motor-generator of claim 1, further providing a plurality of carbon fiber disposed along the circumference of the flywheel.

3. The electric motor-generator of claim 1, wherein each annular magnet comprising a plurality of north and south magnet internals.

4. The electric motor-generator of claim 1, further comprising a plurality of motor windings, wherein the front and rear sidewalls form a plurality of winding apertures disposed concentrically about the rotary cavity, and wherein the plurality of motor windings extend between adjacent winding apertures.

5. The electric motor-generator of claim 1, wherein each magnetized plate provides a plurality of electromagnetic connectors.

6. The electric motor-generator of claim 1, further comprising a mounting box having a front mounting wall and a rear mounting wall interconnected by a base wall, wherein each mounting wall is connected to one magnetized plate.

7. The electric motor-generator of claim 6, further comprising a bottom magnet disposed between the base wall and the stator.

8. The electric motor-generator of claim 1, further comprising a front ball and a rear ball, each ball operatively engaging an opposing end of the flywheel shaft so as to facilitate high rotational speeds about the axis of rotation.

9. An electric motor-generator comprising:
a stator extending from a front sidewall to a rear sidewall, wherein the stator comprises:
a rotary cavity formed between the front and rear sidewalls of the stator;
a plurality of winding apertures formed by the front and rear sidewalls so as to be disposed concentrically about the rotary cavity; and
a plurality of motor windings extending between adjacent winding apertures;
a rotor centered in the rotary cavity, wherein the rotor comprises:
a pair of magnetized plates, wherein each magnetized plate provides a plurality of electromagnetic connectors;
a flywheel shaft having a front end and an opposing rear end, each end extending beyond the rotary cavity so as to be rotably connected to one of the pair of magnetized plates;
an axis of rotation oriented generally parallel to the front and rear sidewalls;
a front ball and a rear ball, each ball operatively engaging an opposing end of the flywheel shaft so as to facilitate high rotational speeds about the axis of rotation;
a flywheel coupled to the flywheel shaft; and
a plurality of carbon fiber disposed along the circumference of the flywheel;
a shaft recess formed into each magnetized plate, wherein each shaft recess provides a plurality of electromagnets and electromagnet coils disposed about each end of the flywheel shaft;
an annular magnet dispose near each end of the flywheel shaft not in its respective shaft recess, wherein each annular magnet comprising a plurality of north and south magnet internals;
a mounting box having have a front mounting wall and a rear mounting wall interconnected by a base wall, wherein each mounting wall is connected to one magnetized plate; and
a bottom magnet disposed between the base wall and the stator.

10. An opposing rotation configuration of two of the electric motor-generator of claim 9.
